(19) United States
(12) Patent Application Publication
(10) Pub. No.: US 2004/0006183 A1
(43) Pub. Date: Jan. 8, 2004

(54) Method of removing protein from dipped latex rubber goods

(76) Inventors: Balanchandra Chakkinggal Sekhar, Selangro (MY); Gopinati Balachandra Sekhar, Kusla Lumpur (MY)

Correspondence Address: Vincent J Gnoffo, Brinks Hofer Gilson & Lione, PO Box 10395, Chicago, IL, 60610, US

(21) Appl. No.: 10/363,186

(22) PCT Filed: Sep. 4, 2001
(86) PCT No.: PCT/IB01/01893

(30) Foreign Application Priority Data
Sep. 6, 2000 (GB) 0021874.3

(51) Int. Cl. C08F 8/00

(52) U.S. Cl. 525/369

(57) ABSTRACT

A method of removing protein from dipped latex rubber goods comprises: a) removing any corn starch powder which has previously been applied to the goods, by treating the goods with hot water to dissolve the powder; b) treating the goods with an aqueous solution comprising an alkali metal hydroxide to remove protein; and c) treating the goods with one or more surface active agents in aqueous solution to remove remaining protein.

This invention relates to a method of removing proteins from dipped latex rubber goods, in particular rubber gloves.

Hevea Brasiliensis latex (Natural Rubber or NR Latex) is the preferred material for examination gloves, surgical gloves and many other kinds of dipped goods. 25 to 30 billion natural rubber latex gloves per year are supplied to the world market. Gloves account for 45% of the total natural rubber latex consumption, with balloons, adhesives, foam, carpet backing and other uses accounting for around 50%. Condoms account for 2%.

In recent years the use of natural rubber latex has been seriously threatened by the emergence of protein allergy. There are in fact three health problems associated with the use of NR latex, respectively arising from irritants, nitrosamines and latex protein allergies. The last allergy factor is unique to Hevea Brasiliensis (NR) latex. Allergic reactions are an over-reaction of an individual's immune system to contact with or exposure to a substance which may otherwise be harmless. It is the genetic makeup of an, individual that predisposes a person to be allergic to NR latex proteins. For example, people who are atopic are generally allergic to latex proteins. The protein allergy problem has increased dramatically during the last 15 years.

Various attempts have been made by the dipped goods industry to reduce latex protein allergy problems. These have included reduction of extractable protein by leaching; chlorination; creating a barrier between the glove and the individual; and in some cases abandoning NR latex and substituting it with synthetic rubber lattices. However, natural rubber latex has a unique balance of properties combining strength, softness and elasticity. No alternative synthetic materials match this balance of properties. Natural Rubber Latex is a very forgiving material as people can, for example, wear undersized medical gloves with comfort. Also, on the basis of sterilizability, safety, cost and availability, natural rubber latex is a highly competitive material.

The range of amounts of proteins in commercial NR latex examination gloves varies from day to day and from batch to batch and can be as low as 50 micrograms per gram up to more than 1,000 micrograms per gram.

According to the present invention there is provided a method of removing protein from dipped latex rubber goods which method comprises:

(A) removing any corn starch powder which has previously been applied to the goods, by treating the goods with hot water to dissolve the powder;

(B) treating the goods with an aqueous solution comprising an alkali metal hydroxide to remove protein; and

(C) treating the goods with one or more surface active agents in aqueous solution to remove remaining protein.

The invention also provides dipped latex rubber goods made from Hevea Brasiliensis (NR) latex which display extractable protein levels below 20 microgram per gram.

The method of the present invention is able to achieve reductions in protein in dipped latex rubber goods to protein levels below the sensitivity level of present analytical techniques available to determine extractable protein level, which is 20 micrograms per gram.

The method of the invention is a series of simple treatments which will effectively remove extractable proteins adsorbed on and absorbed in natural rubber latex gloves and any other latex dipped products. Dipped latex products, particularly gloves, subjected to the method of the invention can be safely classified as NEP (No Extractable Protein). The method of the invention can treat powdered gloves with protein levels in excess of 1,500 micrograms per gram and can be used to render them substantially free of extractable protein.

The method of the invention can be incorporated in the regular factory process for producing dipped latex goods in which case a powdering step may optionally be omitted, but preferably is carried out as a separate off-line operation. It is cost effective and can enable the latex rubber industry to market powdered gloves, siliconized gloves or chlorinated gloves all with no extractable proteins, i.e. with protein levels below 20 micrograms per gram.

The stepwise method of the invention may comprise a first step, step (A) which is described above and which is only necessary if the dipped latex rubber goods to be treated are powdered, goods; that is, if they have previously been treated by applying a layer of cornstarch particles to them to improve their surface lubricity. Step (A) can bring the protein level down to ar und 50 μg/g. Step (B) further reduces the level of protein and Step (C) renders the goods extractable protein free.

Following is a description by way of example of a method in accord with the invention.

Step (A)

Powdered gloves with protein levels ranging from 800 to 1,500 micrograms per gram are immersed in water, the temperature of which is maintained at 80-98° C., for up to 10 minutes. The water and the high temperature act together to remove the cornstarch powder from the gloves, causing the powder to dissolve in the water. Removal of the cornstarch powder takes with it adsorbed proteins from the surface of the gloves. Table 1 illustrates the effect.

TABLE 1

| | | Protein Level after |
|---|---|---|
| | Protein Level before | immersion in Hot |
| | Immersion in Hot Water | Water |
| | (micrograms per gram) | (micrograms per gram) |
| Glove Batch X | 969 | 40-50 |
| Glove Batch Y | 1,278 | 50-60 |

Step (B)

The hot water treated gloves, now powder-free, are immersed in a tank of a 0.5% to 2.0% solution of potassium hydroxide (sodium hydroxide may also be used) for from 10 to 30 minutes and then washed with water. This enables the residual free proteins at or just below the surface of the gloves to be removed. Table 2 illustrates this.

TABLE 2

| | Protein Level before | Protein Level after |
|---|---|---|
| | treatment B | treatment B |
| | (micrograms per gram) | (micrograms per gram) |
| GloveBatch X | 40-50 | 20-25 |
| GloveDatch Y | 50-60 | 22-30 |

Step (C)

The gloves after the Step B treatment are immersed and agitated in a tank of water containing 0.1% to 0.5% of a non-ionic surfactant, e.g. that known as Lubrol LW or Vulcastab LW (trade names for an ethylene oxide condensate of cetyl-oleyl alcohol) and 0.1% of sodium dodecyl sulphate or any other textile detergent. After 10 to 20 minutes the gloves are removed, washed and can be powdered, siliconized or chlorinated in a conventional manner. Table 3 illustrates the effectiveness of this step,.

TABLE 3

| | Protein Level before | Protein Level after |
|---|---|---|
| | treatment C | treatment C |
| | (micrograms per gram) | (micrograms per gram) |
| Glove Batch X | 20-25 | * 5-12 |
| Glove Batch Y | 22-30 | * 5-14 |

* These values have no significance as they are below the sensitivity level of the test method, i.e. 20 micrograms per gram.

For an automated process all of these treatments after the removal of the powder with hot water may be carried out with a commercial chlorinator. The solutions after each treatment can be pumped out and used again at least twice. After the final wash chlorination can be carried out. In the case of powdering or siliconization this may also be done in an alternate chlorinator to avoid contamination.

The method of the present invention has particular applicability to dipped latex rubber goods which are intended for medical use, in particular gloves but also other such goods, for example catheters and other articles or components for medical use.

It will also be understood of course that dipped latex rubber goods which have been treated by the method of the present invention are particularly useful to and suitable for persons who have known allergy to proteins, and also in situations where it is desired not to risk the triggering of any protein allergy which may possibly exist.

1. A method of removing protein from dipped latex rubber goods which method comprises:
(A) removing any corn starch powder which has previously been applied to the goods, by treating the goods with hot water to dissolve the powder;
(B) treating the goods with an aqueous solution comprising an alkali metal hydroxide to remove protein; and
(C) treating the goods with one or more surface active agents in aqueous solution to remove remaining protein.

2. A method as claimed in claim 1 wherein the dipped latex drubber goods are rubber gloves.

3. A method as claimed in claim 1 or claim 2 wherein the goods are powdered goods and wherein the treatment with hot water comprises immersing the goods in water at a temperature of from 80 to 98° C. for a period of time up to ten minutes.

4. A method as claimed in any preceding claim wherein the aqueous alkali metal hydroxide solution is an aqueous potassium hydroxide solution.

5. A method as claimed in claim 4 wherein the goods are immersed in a 0.5 percent to 2.0 percent aqueous potassium hydroxide solution for a period of time of from ten minutes to thirty minutes.

6. A method as claimed in any preceding claim wherein the treatment with an aqueous alkali metal hydroxide solution is followed by washing with water.

7. A method as claimed in any preceding claim wherein the surface active agent or agents is or includes a non-ionic surfactant.

8. A method is claimed in claim 7 wherein the non-ionic surfactant is a cetyl oleyl alcohol-ethylene oxide condensate.

9. A method as claimed in claim 7 or claim 8 wherein a non-ionic surfactant is used together with an ionic surfactant.

10. A method as claimed in claim 9 wherein the ionic surfactant is sodium dodecyl sulphate.

11. A method as claimed in any preceding claim which is followed by a powdering, siliconizing or chlorinating treatment.

12. A method as claimed in claim 1 substantially as hereinbefore specifically described.

13. Dipped latex rubber goods made from Hevea Brasiliensis (NR) latex which display extractable protein levels below 20 microgram per gram.

14. Dipped latex rubber goods as claimed in claim 13 which have been treated by the method as claimed in any one of claims 1 to 12.

15. The use of dipped latex rubber goods as claimed in claim 13 or claim 14 for medical purposes.

16. The use of dipped latex rubber goods as claimed in claim 13 or claim 14 by persons having protein allergy.
